(19) United States
(12) Patent Application Publication
(10) Pub. No.: US 2018/0304491 A1
(43) Pub. Date: Oct. 25, 2018

(54) Method for Beveling Veneers

(71) Applicant: Hanses Sägewerkstechnik GmbH & Co. KG, Meschede-Remblinghausen (DE)

(72) Inventor: Josef Hanses, Meschede-Remblinghausen (DE)

(21) Appl. No.: 15/767,951

(22) PCT Filed: Oct. 17, 2016
(86) PCT No.: PCT/EP2016/074899

§ 371 Date: Apr. 12, 2018

(30) Foreign Application Priority Data
Oct. 21, 2015 (DE) 10 2015 117 931.8

(51) Int. Cl. B27D 5/00; B27B 5/04; B27M 3/00

(52) U.S. Cl. CPC B27D 5/006; B27M 3/002; B27B 5/04

(57) ABSTRACT

A method for bevelling veneers (14), in which an edge (26) of the veneer (14) is pressed, by a pressure shoe (44) that extends along the edge, against a base (22) in such a way that the edge projects over the base, and in that a trimming device (28) and a grinding tool (30), which has a grinding surface set at an angle to the plane of the veneer, move along the edge (26) of the veneer such that an edge strip (50) of the veneer is cut-off by the trimming device (28) and the veneer is bevelled by the grinding tool (30).

The invention relates to a method for bevelling veneers.

In the production of veneer laminates, rectangular veneer panels are laid one upon the other in several layers and are glued together under the action of pressure. In a process that is designated as “book laying”, the veneer panels are laid together to form an endless string wherein the joints between the edges of the veneer panels that succeed one upon the other in the direction of the string are offset from layer to layer, so that a stable interengaging pattern is obtained.

In order to further increase the strength, it is common practice to bevel the veneer panels at the edges that extend in transverse direction of the string, i.e. the panels are chamfered such that they are given a wedge-shaped profile in transverse direction of the string. The bevelled edges of the adjacent veneer panels are then laid together with overlap, so that the overlapping wedge profiles of the two panels complement each other to the full thickness of the veneer.

Saws or milling tools are commonly used for bevelling the veneers. A distinction is made between dry bevelling and wet bevelling. In a dry bevelling process, the bevels are not milled before the veneers have passed through a dryer. Since, however, the wood is relatively hard in that case, sawing or milling can easily produce cracks and broken-out parts in the wedge-shaped veneer edges, and this is undesired in particular in the cover layers, i.e. the topmost or bottom-most veneer layer of the laminate, because the improperly bevelled edges are then visible in the final product.

DE 887 702 C discloses a wet bevelling process wherein bevelling is performed already in the process of cutting the veneers, i.e. in a condition in which the wood is relatively humid and soft. Even this method, however, does not yield perfectly bevelled edges.

It is an object of the invention to provide a method that permits to obtain bevelled veneer edges with improved quality.

According to the invention, in order to achieve this object, an edge of the veneer is pressed, by means of a pressure shoe that extends along said edge, against a base in such a way that the edge projects over the base, and in that a trimming device and a grinding tool, which has a grinding surface set at an angle to the plane of the veneer, move along the edge of the veneer such that an edge strip of the veneer is cut off by the trimming device and the veneer is bevelled by means of the grinding tool.

With the grinding tool, the edge of the veneer can be processed gently, so that the formation of cracks and broken-out parts is reduced significantly. Moreover, by means of the trimming device, e.g. a slitting saw or a chopper, a straight cut is made at the tapered end of the bevel zone, so that a straight and neat butting edge is obtained. This improves not only the optical appearance but facilitates also a detection of the edge with an electronic measuring system (camera, light curtain or scanner), so that the book laying process can be controlled more precisely and the veneers can be laid more accurately.

Useful details and further developments of the invention are indicated in the dependent claims.

When the trimming device and the grinding tool move along the edge of the veneer, the grinding tool preferably follows behind the trimming device. Since, then, the edge strip that has been cut away or chopped with the trimming device does not need to be ground, the wear of the grinding tool is reduced and a higher processing speed can be achieved.

The trimming device and the grinding tool can be adjusted such that the thickness of the veneer at the edge that is formed by the trimming device is reduced to zero by the grinding tool, so that the bevel zone is phased-out in an acute angle. However, an adjustment may also be made such that there remains a butted edge, the thickness of which is however so small that it does not appear as a defect after book laying. On the other hand, this butted edge increases the robustness of the veneer against shocks and other mechanical attacks and reduces the sensitivity for variations in the grinding depth, so that a very smooth and straight edge is obtained.

The method is preferably performed in a dry bevelling process after the veneers have been dried.

The invention relates also to a device for carrying out the method that has been described above, and to a method of producing veneer laminates that is based on the method described above.

In an advantageous embodiment, the bevelling method that has been proposed here is used only for the veneer panels that are to form the cover layers of the veneer laminate. The internal veneer layers, the bevelled edges of which are no longer visible in the final product, may be bevelled already in a wet bevelling process at the time of cutting the veneer.

It is also possible to apply the wet bevelling process to all veneers and then to post-bevel the veneers that are to form the cover layers in the dry bevelling process according to the invention. Since, in this case, a certain chamfer at the edge of the veneer has been formed already in the wet bevelling process, there is less material that has to be removed by means of the grinding tool, so that the processing speed and the endurance of the grinding tool can be increased.

However, this method has the consequence that the post-bevelled veneers for the cover layers have a smaller length than the veneers for the inner layers. This can however be accounted for by performing the book laying process for the covering layers in a somewhat asynchronous mode, i.e. with a rhythm that is different from that for laying the inner layers.

An embodiment example will now be described in conjunction with the drawings, wherein:

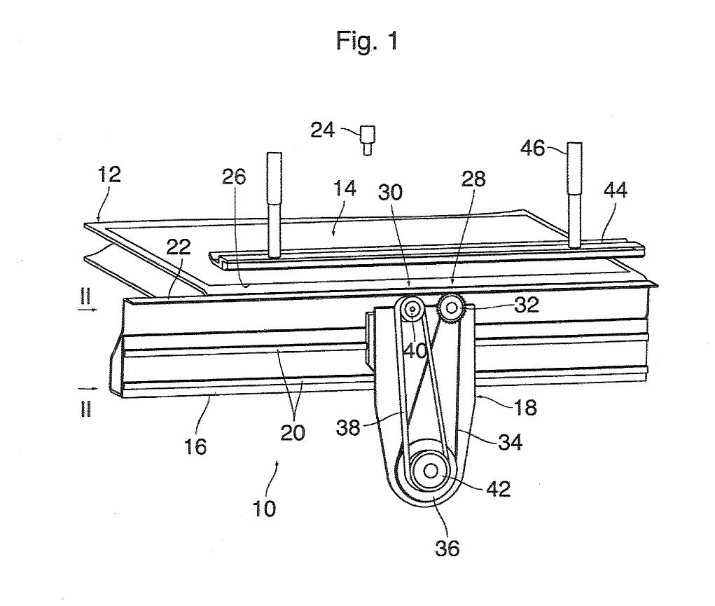

FIG. 1 is a perspective view of the essential parts of a device for bevelling veneers in accordance with the method according to the invention;

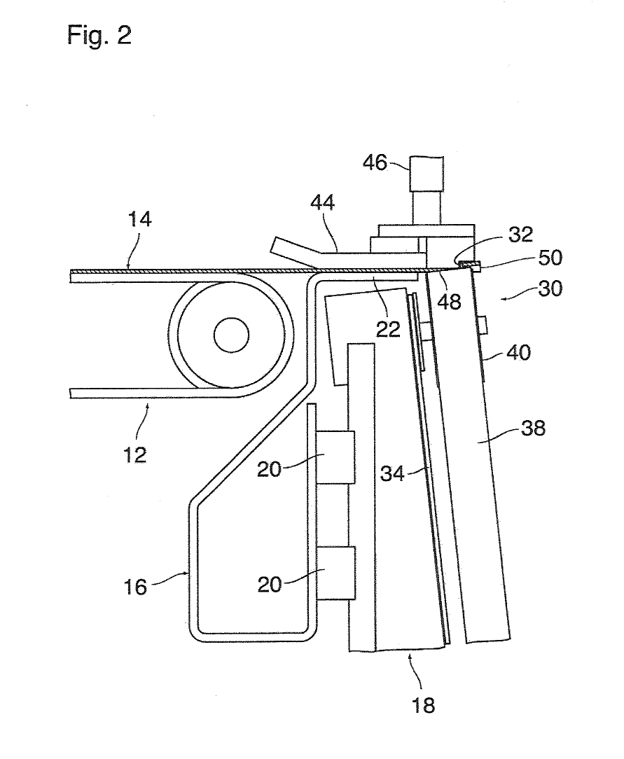

FIG. 2 is a side view of the device as seen in the direction of arrows II-II in FIG. 1;

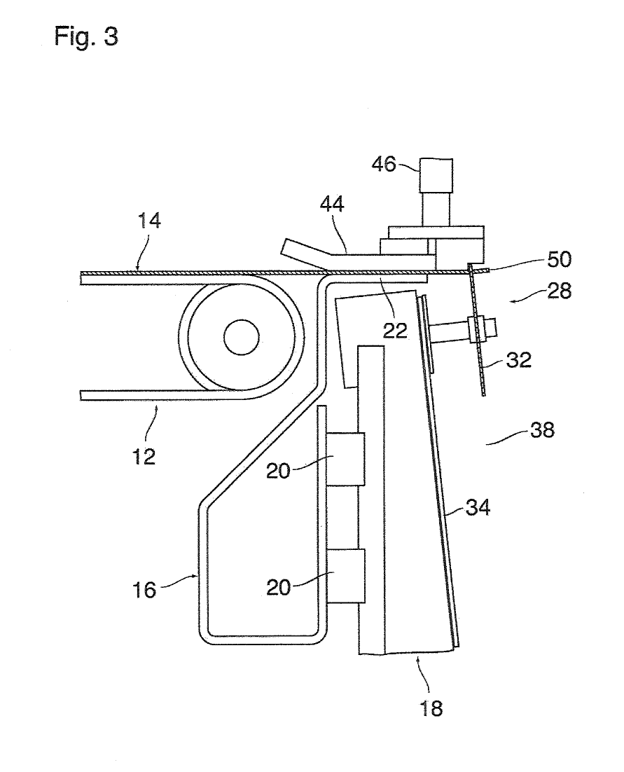

FIG. 3 is a view analogous to FIG. 2, but with a grinding tool being removed, so that a slitting saw arranged behind the same becomes visible more clearly;

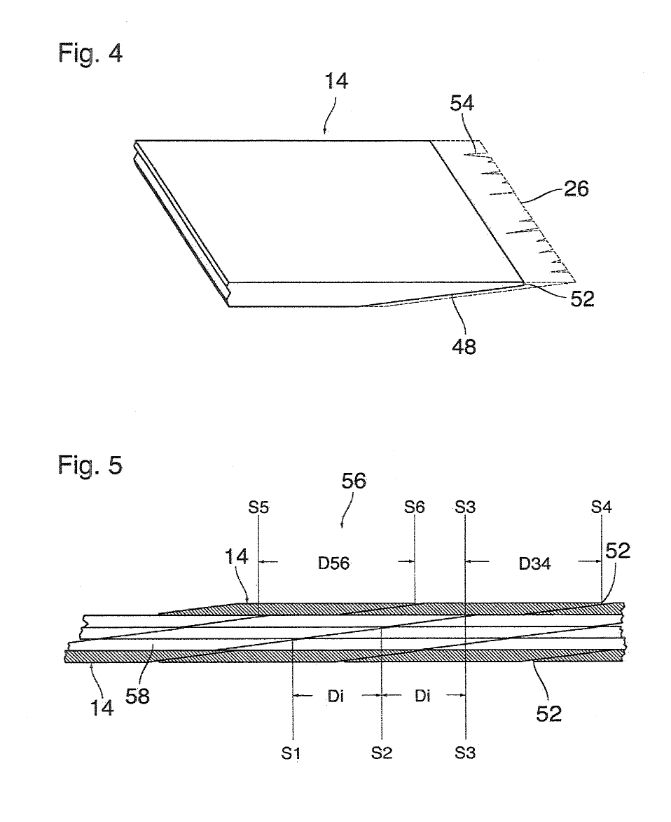

FIG. 4 is a perspective view of a bevelled veneer edge; and

FIG. 5 is a side view of a part of a multi-layer veneer string for the production of veneer laminates.

In FIG. 1, a bevelling device 10 has been shown that is arranged at an end of a belt conveyer 12. The belt conveyer 12 supplies rectangular veneer panels 14 that have previously been dried in a drying station which has not been shown, the panels having also been sorted for quality in a sorting station which has not been shown, neither. Only those veneer panels 14 that are essentially free of defects and have such a high quality that they are suitable as cover layers of a veneer laminate are supplied to the bevelling device 10.

The bevelling device 10 has a rail-like frame 16 that extends at the end of the belt conveyer 12 in transverse direction of the belt conveyer over the entire width of the latter. A carriage 18 is guided along guide rails 20 and is movable along the frame 16.

An upper profile part of the frame 16 forms a base 22 that is flush with the top side of the belt conveyer 12.

In the example shown, a camera 24 which permits to detect the timing of a passage of a leading edge 26 of a veneer panel 14 is arranged above the belt conveyer 12. The drive system of the belt conveyer 12 is controlled such that the veneer panel 14 is pushed beyond the end of the belt conveyer and onto the base 22 until its leading edge 26 projects slightly from the base 22.

A trimming device 28 and a grinding tool 30 are mounted on the carriage 18.

In the example shown, the trimming device 28 is a slitting saw having a circular saw blade 32 that is driven via a belt drive 34 by a drive disk 36 that itself is driven for rotation. Optionally, the trimming device may also be formed by a chopper which completely chops the strip of material that has been cut away.

The grinding tool 30 has an endless grinding tape 38 running over a pulley 40 and a corresponding cylindrical part 42 of the drive disk 36.

In an initial position, the carriage 18 is located in an end portion of the frame 16 outside of the width of the belt conveyer 12 at the left end in FIG. 1, so that the trimming device and the grinding tool do not interfere with the advance of the veneer panel 14. Once the veneer panel has been pushed forward into the desired position, a pressure shoe 44 that extends in parallel with the base 22 is lowered by means of pneumatic, hydraulic or electric drive systems 46 so that it presses the edge zone of the veneer panel 14 against the base 22 in order to immobilize the veneer panel. Subsequently, the carriage 18 travels from left to right in FIG. 1, so that the saw blade 32 cuts away a narrow edge strip from the projecting part of the veneer panel 14, whereupon the grinding tool 30 grinds the bottom side of the veneer panel so as to form an inclined ground surface, whereby the veneer panel is bevelled at the edge 26.

Subsequently, the pressure shoe 44 is lifted again, the veneer panel 14 is slightly withdrawn with belt conveyer 12 and is then lifted by a suction rig that has not been shown and is transferred onto a laying line on which a multi-layer string of veneer panels is laid, as will be described later.

As can been seen in FIG. 2, the axis of the pulley 40 for the grinding tape 38 as well as the axis of the saw blade 32, which is however almost completely hidden in FIG. 2, are slightly inclined relative to the plane of the veneer panel 14, so that the grinding tool will create a bevel 48 with wedge-shaped profile at the edge of the veneer panel.

Also visible in FIG. 2 is an edge strip 50 of the veneer panel which, although it has already been separated from the veneer panel by the saw blade 32 at the position of grinding tool 30, it is still part of the veneer panel, unless it is broken away.

The trimming device 28 with the saw blade 32 has been shown in FIG. 3.

FIG. 4 shows an edge zone of the veneer panel 14 in a state after bevelling. What is seen here is the wedge-shaped bevel 48 which, however, does not phase-out acutely at the free end, but forms a butted edge 52 with low height. The height of the butted edge 52 can be controlled by adjusting the height of the grinding tool 30 relative to the base 22.

The initial condition of the edge 26 of the veneer panel has been shown in phantom lines in FIG. 4. It is assumed here that the veneer panel 14 had already been subjected to a pre-bevelling process, e.g. a wet bevelling process prior to drying the veneers, before the panel reaches the bevelling device 10 that is being described here. For this reason, the edge 26 has already a wedge-shape even in the condition in which it reaches the bevelling device 10, but this wedge-shape is disturbed by numerous cracks and broken-out parts 54. In the bevelling process performed with the bevelling device 10, these cracks and broken-out parts are removed, so that a neatly bevelled edge is obtained.

FIG. 5 schematically shows a side view of a string 56 of veneer panels 14 and 58 to which an adhesive has been applied and which are superposed in several layers. The string 56 is conveyed from left to right in FIG. 5 on a laying line that has not been shown in detail, and is moved towards a press which has not been shown, neither. The topmost and lowermost cover layers of the string 56 are formed by veneer panels 14 that have been bevelled or post-bevelled in the bevelling device 10 in accordance with the method described above. The inner layers are formed by veneer panels 58 that have only been subjected to a wet bevelling process. It can be seen that the wet bevelling of the veneer panels 58 and also the bevelling of the veneer panels 14 of the outer layers has been performed respectively at both edges that extend in transverse direction of the sting, so that the panels can overlap with their bevelled parts and thereby form a veneer layer with essentially constant thickness.

It should be noted that the bevels at both edges of each veneer panel are formed on the same side of the panel, namely on the bottom side in the example shown. However, the bevel zones which are later superposed by the bevel zone of the panel that is laid next (at the left end of each panel in FIG. 5) are bent downwards due to the weight of the superposed layers (and in the subsequent process of pressing the string, at the latest), so that it appears in FIG. 5 as if the panels had been bevelled at the top side at their left end.

FIG. 5 shows only three inner layers of the veneer panels 58. In practice, however, the number of inner layers is in most cases significantly larger. Also the thickness of the individual veneer panels 14 and 58 relative to the length thereof has been exaggerated in FIG. 5.

In the example shown, the (post-)bevelling with the bevelling device 10 is performed only on one edge of each veneer panel 14, at the right end in FIG. 5 in case of the topmost cover layer. In this way, the top side of the top cover layer of the string 56 is formed with the straight and neatly butted edges 52 which assure a good appearance of the resulting veneer laminate body after pressing. At the opposite ends of the veneer panels 14 (on the left side in FIG. 5), a post-bevelling is dispensable because these edges are obscured anyway by the superposed bevel zone of the respective subsequent veneer panel.

However, when the lowermost cover layer is formed, the veneer panels 14 are laid in reverse orientation, so that the neatly butted edges 52 are respectively formed at the left end of each panel, i.e. at the end that is visible from outside.

In the condition in which the veneer panels 14 and 58 leave the drying station, all panels have essentially the same rectangular shape in plan view. However, the veneer panels for the cover layers are slightly shortened by the post-bevelling process in the bevelling device 10, so that they do no longer fit exactly into the raster of the veneer panels 58 of the inner layers.

For this reason, the following process is applied for laying the veneer panels that will finally form the string 56: At first, the veneer panels 14 of the bottom cover layer are laid. Meanwhile the veneer panels 58 of the inner layers are laid into “books” which consist respectively of superposed and staggered panels, i.e. three panels in the example shown, and N panels in the general case, wherein N is the number of veneer panels of the inner layers of the string. The individual books are then placed one after the other on the lower cover layer and are thereby adjoined such that, together, they form the core of the string 56. Subsequently, the veneer panels 14 of the top cover layer are laid.

In FIG. 5, the position of the leading edge of a lower veneer panel 58 of a book has been designated as S1. S2 designates the position of the leading edge of the central veneer panel 58 of the same book, and, correspondingly, S3 designates the position of the leading edge of the top veneer panel 58 of this book. It can be seen that the distance Di between the positions S1 and S2 is the same as the distance between the positions S2 and S3. Thus, the offset of the veneer panels from layer to layer fits into a uniform raster for all inner layers.

S4 designates the position of the leading edge of the veneer panel 14 that is superposed on the book that ends at S3. The distance D34 between these positions is clearly different from Di. S5 designates the position of the leading edge of the topmost veneer panel 58 of the subsequent book, and S6 designates the position of the leading edge of the corresponding veneer panel 14 in the top cover layer. The distance D56 between these positions is not only different from Di but is also different from the distance D34 between the preceding pair of veneer panels in the same layers. Thus, the veneer panels 14 of the cover layers are laid in their own clock rate that depends upon the length of the veneer panels and is different from the clock rate of the successive books in the inner layers.

However, if the veneer panels 14 are all given the same length in the bevelling device 10, the laying of the bottom and top cover layers can be performed with a constant clock rate that is only different from the clock rate for laying the books of the inner layers.

However, it is also possible to control the bevelling device 10 and the belt conveyer 12 such that the lengths of the post-bevelled veneer panels 14 vary. For example, the camera 24 may be used for detecting cracks and broken-out parts in the pre-bevelled edge 26 and to assess them electronically. The length with which the edge 26 projects beyond the base 22 and, consequently, the width of the edge strip 50 that is cut away with the saw blade can therefore be made dependent upon the size of the broken-out parts. In that case, it is convenient that, in the process of laying the veneer panels 14, the leading and trailing edges of the veneer panels are also detected electronically and the laying process is controlled such that the veneer panels are adjoined to one another with the correct overlap of the bevel zones.

Eventually, it may even be possible in this variant of the method to remove any defects from the interior of the veneer panel 14. If, for example, a non-tolerable defect is found for example close to the leading edge 26, the belt conveyor 12 may be controlled such that this defect is brought into a position beyond the base 22, so that the defective part of the panel is cut away with the trimming device 28. Since, in this case, the cut made with the saw blade will generally be made at a position where the veneer panel has its full thickness, the grinding tool 30 is required to remove more material. To that end, the speed at which the carriage 18 is moved over the width of the veneer panel may be adapted, if necessary.

What is claimed is:

1. A method for bevelling veneers, comprising the steps of:
pressing an edge of a veneer, by a pressure shoe that extends along said edge, against a base in such a way that the edge projects over the base, and
moving a trimming device and a grinding tool, which has a grinding surface set at an angle to a plane of the veneer, along the edge of the veneer such that an edge strip of the veneer is cut-off by the trimming device and the veneer is bevelled by the grinding tool.

2. The method according to claim 1, wherein the step of moving including the step of moving the trimming device and the grinding tool along the edge of the veneer together.

3. The method according to claim 1, wherein the step of moving along the edge of the veneer, includes the step of arranging the trimming device and the grinding tool such that the trimming device precedes the grinding tool.

4. The method according to claim 1, further including the steps of:
supplying the veneer to the base on a conveyer,
electronically detecting the edge of the veneer during transport on the conveyor, and
controlling the length by which the edge projects beyond the base by controlling the conveyor.

5. The method according to claim 4,
wherein the step of electronically detecting includes the step of detecting the edge of the veneer with a measuring system,
further including the step of assessing a condition of the edge by processing measurement data obtained from the previous step, and
wherein the step of controlling includes the step of controlling the length of projection of the edge over the base on the basis of the assessed condition of the edge.

6. An apparatus for carrying out the method according to claim 1, comprising:
a frame forming a base for a veneer panel;
an adjustable pressure shoe for pressing the veneer panel against the base; and
a carriage that is arranged to move on the frame along an edge of the veneer panel, the carriage carrying the trimming device for cutting away an edge strip from the edge of the veneer panel, and the grinding tool for grinding the edge.

7. The device according to claim 6, further comprising:
a conveyor for supplying the veneer panel to the base, and
a measurement system arranged above the conveyor for detecting the edge of the veneer panel during transport of the veneer panel on the conveyor.

8. The device according to claim 7, wherein the measurement system includes at least one of:
a camera,
a light curtain, and
a scanner.

9. A method of producing a veneer laminate, comprising the steps of:
laying a string of several layers of bevelled veneer panels, with an adhesive applied to the veneer panels,
wherein at least the veneer panels that form a cover layer of the string are bevelled in accordance with the method according to claim 1.

10. The method according to claim 9, wherein all veneer panels are bevelled at opposite edges that extend in a transverse direction of the string before the veneer panels for the cover layer are post-bevelled in accordance with the method according to claim 1.

11. The method according to claim 9, wherein the step of laying includes the step of laying the veneer panels for the cover layer synchronously with respect to the veneer panels of the inner layers.
